(19) United States
(12) Patent Application Publication
(10) Pub. No.: US 2017/0113857 A1
(43) Pub. Date: Apr. 27, 2017

(54) CABLE TIE FOR MOUNTING CABLES AGAINST A PANEL

(71) Applicant: ONE INVENTOR SWEDEN AB, Jarfalla (SE)

(72) Inventor: Jan Berglund, Jarfalla (SE)

(73) Assignee: ONE INVENTOR SWEDEN AB, Jarfalla (SE)

(21) Appl. No.: 15/397,425

(22) Filed: Jan. 3, 2017

Related U.S. Application Data
(63) Continuation-in-part of application No. 14/354,999, filed on Apr. 29, 2014, now Pat. No. 9,533,808.
(60) Provisional application No. 62/416,768, filed on Nov. 3, 2016.

(30) Foreign Application Priority Data
Aug. 22, 2012 (SE) 1230082-8

(51) Int. Cl. B65D 63/10; G09F 3/14; F16L 3/137

(52) U.S. Cl. CPC B65D 63/1027; F16L 3/137; G09F 3/14; B65D 2563/108; B65D 2563/107

(57) ABSTRACT

A cable tie with means to form a loop in order to mount cables against a panel or a marking badge. The cable tie has an integrated panel anchor having an elongated body or can be folded into an elongated body. The cable tie is intended to be mounted in a panel that has an opening with a long and narrow shape that could be combination with a circular hole. The mounting starts with a bending around the panel anchor which is then mounted into the opening. Then the cable tie is rotated typically 90° around the axis normal to the panel. Then by releasing the bending, the band on each side of the panel anchor is fixed in the elongated part of the opening and the panel anchor is fixed towards the back-side of the panel.

### PRIORITY

The present application a) is related to, and claims the priority benefit of, U.S. Provisional Patent Application Ser. No. 62/416,768, filed Nov. 3, 2016, and b) is related to, claims the priority benefit of, and is a U.S. continuation-in-part application of, U.S. patent application Ser. No. 14/354,999, filed Apr. 29, 2014 and issued as U.S. Pat. No. 9,533,808 on Jan.3, 2017, which is related to, claims the priority benefit of, and is a U.S. National Stage §371 application of, International Patent Application Serial No. PCT/SE2013/050962, filed Aug. 10, 2013, which is related to, and claims the priority benefit of, Sweden Patent Application Serial No. 1230082-8, filed Aug. 22, 2012. The contents of each of the aforementioned patent applications and patent are hereby incorporated into the present disclosure by reference in their entirety.

### BACKGROUND

Cable ties made of plastic, normally Nylon (PA), is a commonly used technique to mount things to each other. The big advantage is that they are very robust and the loop they create is very flexible in size in the way that one single cable tie can be used to fasten things of different sizes. But when fastening a bunch of cables against something, you normally do need to let the cable tie go around that something When it is to be fastened against a panel or a plate, two holes can make it, if you enter in one and go back out through the other and then form the loop around the cables. One problem is that one does not always have access to the backside of the plate. In different kinds of machines, it is normal that the cables are fastened against the chassis or similar where there is no access to the backside to enable you to enter one hole and go back in another. With the present invention and the specially shaped hole in the same chassis we can just enter the anchor part through the hole and rotate 90°, and then form the loop around the cable bunch.

One type of existing cable tie has a snap function in order to snap into a round or square hole, see for example Franks (WO2005/099402). These are mostly adapted for one particular panel thickness, but there are types that are designed to fit for two different thicknesses by having two snap functions at different depth. The type that snaps into a round hole doesn't have a locking function against rotation. Normally these are also difficult to dismount without having access to the backside of the panel since you normally have to squeeze the snap function together from the back in order to dismount it. There are cable ties that are dismountable from the front but then the snap function tends to grow so that the cable(s) no longer is close to the panel. When the cable is mounted offset from the panel the robustness against mechanical vibration declines significantly. Also, for reason of electromagnetic disturbances (EMC-problems) it is better to have the electrical cables clamped close to a metallic plate, it prevents the cable from becoming an antenna dipole that can send or receive electromagnetic noise.

Yet another type of panel mounting for cable ties is a so-called tree-mounting type, it has a protruding mechanism that looks like a Christmas-tree with branches of decreasing length closer to the top. The mechanism is mounted into a round or square hole with the top first and its branches are deformed and the mechanism gets stuck. This type is independent of the panel thickness and it can even fit into different sizes of holes but is not very robust against vibrations and can easily get loose if exposed to forces and vibrations. A somewhat similar type has a part of a plastic rivet integrated with the cable tie, it's a tube-like protrusion that is split in two halves from the tip. The protrusion is mounted into the hole and then a plastic sprint is pushed into the tube protrusion forcing the two halves aside and making it expand on the backside of the panel. They are robust but consist of two parts and are therefore more expensive. When mounted, the bend is quite tough and puts a lot of stress to the split tube part and can cause it to break, especially in the winter when the humidity in the air is low. It works on one thickness only and also lacks protection against rotation.

There are also cable ties with one surface covered with adhesive to be attached to the plate, or a hole for screw mounting it towards the panel. They can either be integrated with the cable tie or a separate part with a small loop that the cable tie can be mounted through. The advantage with the adhesive type is that you don't have to make a hole in the panel but it is hard to find the balance between sticking to the plate and a possibility to remove it later on. With time adhesives also have a tendency to dry out and loose the adhesiveness, especially in a warm environment, as in many machines. The type with a screw is very robust but a threaded hole has to be made either directly in the panel if it is thick enough or by mounting a thread insert. The problem is that it takes time to both make the thread and then screwing it in place. To simply punch a hole, even if it is a little bit complex is very cheap and is made automatically.

### BRIEF DESCRIPTION

In at least one embodiment of a cable tie with means to form a loop of the present disclosure, said cable tie is intended to be used for attaching cables or similar details against a panel with the use of an integrated panel anchor, said panel anchor is mounted into an opening in said panel, said cable tie is characterized by A. having an elongated band in a vicinity of the panel anchor; B. having the integrated panel anchor having a wide flat square or rectangular shape with one or more weaker elongated segments perpendicular to a longitudinal axis of the cable tie and where said weaker segments are i. made of grooves and/or, ii. made of cut through slots and/or, iii. made of an elastomeric bridge; and; C. that said panel anchor can be folded in said weaker segments into a folded panel anchor and; D. that said folded panel anchor is intended to be mounted in through a long and narrow opening of the panel and that the cable tie thereafter is rotated 90° relative to the panel and around a normal axis of the panel so that edges of the folded panel anchor that are parallel to the weaker segments are locked against a back side of the panel and the cable tie on each side of the panel anchor is locked against further rotation on a front side in both ends of the long and narrow opening due to remaining tension from said folding.

In at least one embodiment of a cable tie with means to form a loop of the present disclosure, the cable tie is intended to be mounted in panels of different thicknesses.

In at least one embodiment of a cable tie with means to form a loop of the present disclosure, parts of the band have at least one of its two flattened surfaces ribbed.

In at least one embodiment of a cable tie with means to form a loop of the present disclosure, the cable tie has a locking device in one of its ends consisting of a hole aimed to receive at least part of the ribbed band therein and completely therethrough and thus creating a loop where a locking mechanism locks the loop in a tightened position.

In at least one embodiment of a cable tie with means to form a loop of the present disclosure, the cable tie has a release mechanism to release the locking mechanism and by that opening up the loop.

In at least one embodiment of a cable tie with means to form a loop of the present disclosure, the cable tie is made of plastic.

In at least one embodiment of a cable tie with means to form a loop of the present disclosure, the panel is replaced with a marking badge.

The present disclosure includes disclosure of a cable tie with means to form a loop, said cable tie is intended to attach cables or similar details against a panel with use of an integrated panel anchor, said panel anchor is mounted into an opening in said panel, the cable tie is characterized by; a, having an elongated band in a vicinity of the panel anchor and; b, the panel anchor having a long and narrow body with its longitudinal axis perpendicular to, or at least not parallel with, the elongated band and; c, that portions of the cable tie proximal and distal to the panel anchor are configured to change direction in, and/or in a vicinity of a point where the panel anchor is integrated with the cable tie and; d, the panel anchor intended to be mounted into a panel opening having a shape that is a combination of a long and narrow opening which is longer than the panel anchor and a circle with a diameter that is smaller than a length of the panel anchor and; e, that said panel anchor is intended to be mounted in and completely through the long and narrow opening while said portions of the cable tie proximal and distal to the panel anchor are gently bent toward each other and that the cable tie thereafter is rotated around the axis of a circular part of the opening so that a top-side of utmost parts of the panel anchor thereby is locked towards a back-side of the panel and the band on each side of the panel anchor is locked against further rotation on a front-side when said portions of said cable tie proximal and distal to the panel anchor are released so to restore the cable tie to its original shape and at least part of said portions of said cable tie proximal and distal to the panel anchor are positioned in both ends of the long and narrow part of the opening; and wherein an integration point between the cable tie and the panel anchor is indented into the panel anchor.

The present disclosure includes disclosure of a cable tie with means to form a loop, that is intended to be mounted in panels of different thicknesses in that it has curves in a vicinity of the panel anchor.

The present disclosure includes disclosure of a cable tie with means to form a loop, with thinner sections on both sides of the panel anchor.

The present disclosure includes disclosure of a cable tie with means to form a loop, with segments of a circle extruded from an elongated body of said panel anchor and with a common diameter being slightly smaller than a diameter of the circular part of the opening.

The present disclosure includes disclosure of a cable tie with means to form a loop, where parts of the band have at least one of its two flattened surfaces ribbed.

The present disclosure includes disclosure of a cable tie with means to form a loop, with a locking device in one of its ends consisting of a hole aimed to receive at least part of the ribbed band therein and completely therethrough and thus creating a loop and where a locking mechanism locks the loop in a tightened position.

The present disclosure includes disclosure of a cable tie with means to form a loop, with a release mechanism to release the locking mechanism and by that opening up the loop.

The present disclosure includes disclosure of a cable tie with means to form a loop, whereby rotation of said panel anchor relative to said panel and tightening said band around said cables or similar details by positioning the first end of said band in and completely through said locking mechanism further locks and further tightens said panel anchor against said panel.

The present disclosure includes disclosure of a cable tie with means to form a loop, where the panel is replaced with a marking badge.

The present disclosure includes disclosure of a cable tie, comprising an elongated and generally planar band comprising means to form a loop; a panel anchor defined within the band, the panel anchor having a long and narrow body configured to fit completely within a corresponding elongated part of an aperture defined within a panel; wherein portions of the band proximal and distal to the panel anchor are configured to change direction in, and/or in a vicinity of a point where the panel anchor is defined within the band and wherein when the long and narrow body is positioned within the elongated part of the aperture while said portions of the band proximal and distal to the panel anchor are gently bent toward each other, rotation of the band causes the band to be secured within the aperture when said portions of said band proximal and distal to the panel anchor are released so to restore the band to its original shape and so that said portions of said band proximal and distal to the panel anchor are partially positioned within the elongated part of the aperture; and wherein the band forms an indented portion at the panel anchor.

The present disclosure includes disclosure of a cable tie, wherein the means to form the loop can form the loop so that one or more cables are secured within the loop.

The present disclosure includes disclosure of a cable tie, wherein rotation of the band 90° causes the band to be secured within the aperture.

The present disclosure includes disclosure of a cable tie, wherein when the long and narrow body is positioned within the elongated part of the aperture, the long and narrow body is located at a relative back of the panel, and wherein the means to form the loop is/are located at a relative front of the panel.

The present disclosure includes disclosure of a cable tie, wherein a portion of the band comprises a ribbed surface, and wherein the means to form the loop comprises a locking mechanism defining a hole therein and a release mechanism adjacent to the hole.

The present disclosure includes disclosure of a cable tie, with thinner sections on both sides of the panel anchor.

The present disclosure includes disclosure of a cable tie, where an integration point between the cable tie and the panel anchor is indented into the panel anchor.

The present disclosure includes disclosure of a system, comprising: a panel defining an aperture therein, the aperture having an elongated part; and a cable tie, comprising: an elongated and generally planar band comprising means to form a loop comprising a locking mechanism at or near a first end of the band defining a hole therein configured to receive a second end of the band therein and completely therethrough and a release mechanism adjacent to the hole; a panel anchor defined within the band, the panel anchor having a long and narrow body configured to fit completely within a corresponding elongated part of an aperture defined within a panel; wherein portions of the band proximal and distal to the panel anchor are configured to change direction in, and/or in a vicinity of a point where the panel anchor is defined within the band and wherein when the long and narrow body is positioned within the elongated part of the aperture while said portions of the band proximal and distal to the panel anchor are gently bent toward each other, rotation of the band causes the band to be secured within the aperture when said portions of said band proximal and distal to the panel anchor are released so to restore the band to its original shape and so that said portions of said band proximal and distal to the panel anchor are partially positioned within the elongated part of the aperture.

The present disclosure includes disclosure of a system, wherein the aperture of the panel further has a circular part, the circular part configured so that a portion of the cable tie at or near the panel anchor fits within the circular part and so that the portion of the cable tie at or near the panel anchor can rotate within the circular part of the aperture.

The present disclosure includes disclosure of a system, wherein the means to form the loop can form the loop so that one or more objects can be secured within the loop while the cable tie is secured within the aperture of the panel.

The present disclosure includes disclosure of a system, where parts of the band have at least one of its two flattened surfaces ribbed.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIGS. 1a, 1b, and 1c show a cable tie with a panel anchor and an example of means forming a loop in different perspectives, according to exemplary embodiments of the present disclosure;

FIG. 2a shows a main view of a cable tie with associated section view A-A and example of details for forming a loop and direction changes and at point, and also section B-B showing the cross section of the band in the vicinity of the panel anchor, according to an exemplary embodiment of the present disclosure;

FIG. 2b shows a projected view from FIG. 2a, according to an exemplary embodiment of the present disclosure;

FIG. 3 shows the design of the opening in the panel, with an elongated part and a circular part, according to an exemplary embodiment of the present disclosure;

FIG. 4a shows an alternative panel anchor with extruded segments of a circle, according to an exemplary embodiment of the present disclosure;

FIG. 4b shows an alternative panel anchor with extruded segments of a circle mounted in a panel, according to an exemplary embodiment of the present disclosure;

FIG. 5 shows the cable tie with panel before mounting, according to an exemplary embodiment of the present disclosure;

FIG. 6 shows the gentle bending of the cable tie prior to mounting, according to an exemplary embodiment of the present disclosure;

FIG. 7 shows how the panel anchor is inserted into the panel, according to an exemplary embodiment of the present disclosure;

FIG. 8 shows how the cable tie is rotated 90° in the opening, according to an exemplary embodiment of the present disclosure;

FIG. 9 shows the cable tie after recovering from the initial bend, according to an exemplary embodiment of the present disclosure;

FIG. 10 shows how the cable tie have formed a loop around four cables that have been mounted against the panel, according to an exemplary embodiment of the present disclosure;

FIG. 11 shows marking of cables with the use of a marking badge, according to an exemplary embodiment of the present disclosure;

FIG. 12 shows a cable tie with a flat panel anchor containing grooves, according to an exemplary embodiment of the present disclosure;

FIG. 13 shows a cable tie forming a loop, according to an exemplary embodiment of the present disclosure;

FIGS. 14a, 14b, 15a and 15b show the panel anchor with its weakened segments made of grooves and/or cut through slots, according to exemplary embodiments of the present disclosure;

FIG. 16 shows a cable tie with an elastomeric bridge, according to an exemplary embodiment of the present disclosure;

FIG. 17 shows a folded cable tie with an elastomeric bridge where the panel anchor is folded, the folded panel anchor with the elastomeric bridge is shown enlarged in detail C, according to an exemplary embodiment of the present disclosure;

FIG. 18 shows a main view of the cable tie with the length of the panel anchor, the width of the band and the hole of the locking device with associated section view E-E showing details for forming a loop, section view D-D shows the cross section of the band in the vicinity of the panel anchor, according to an exemplary embodiment of the present disclosure;

FIG. 19 shows a projected view from FIG. 18 and the locking device, according to an exemplary embodiment of the present disclosure;

FIG. 20 shows the long and narrow opening in the thin panel, according to an exemplary embodiment of the present disclosure;

FIG. 21 shows an alternative panel that is thicker and therefore also include a circular part of the opening and a chamfer, according to an exemplary embodiment of the present disclosure;

FIG. 22 shows the cable tie with a panel before mounting, according to an exemplary embodiment of the present disclosure;

FIG. 23 shows the bending of the cable tie prior to mounting, detail F shows the folded panel anchor with grooves and the edges, according to an exemplary embodiment of the present disclosure;

FIG. 24 shows how the folded panel anchor is inserted into the panel opening, according to an exemplary embodiment of the present disclosure;

FIG. 25 shows how the cable tie is rotated 90° in the panel opening, according to an exemplary embodiment of the present disclosure;

FIG. 26 shows the cable tie after recovering from the initial bend, according to an exemplary embodiment of the present disclosure;

FIG. 27 shows how the cable tie have formed a loop around four cables, according to an exemplary embodiment of the present disclosure; and

FIG. 28 shows a panel anchor mounted into an opening in a marking badge, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This invention relates to a cable tie with the job to collect and hold one or more cables, tubes, hoses or similar against a panel. The cable tie is made of plastic, normally PA (Nylon). It consists of a band with means to form a loop. This description will focus mainly on a cable tie having one end with a ribbed side and in the other end there is a locking device with a hole that can receive the ribbed part and a locking mechanism inside locking the loop in a tightened position. The function of forming a loop could actually have any kind of mechanism since the claims of the invention is focused around mounting the cables towards the panel. The ends could actually just have holes that one can mount a Velcro band in. But the benefit of the type in the figures is that it is very robust and when it is tightened to engage the locking mechanism it will be even more robustly mounted to the panel as we shall see later. There are types with a release function integrated in the locking mechanism that can open up the loop and dismount the whole cable tie very easily. This also makes it suitable for the invention because one of the advantages of this invention is that it's easy to mount and easy to dismount from the panel. The cable tie is therefore a band of plastic with means to form a loop.

The cable tie has, on a specific place along its length a panel anchor for panel mounting that can be mounted into an opening in the panel. In the areas close to the panel anchor the band has a long and narrow cross-section.

In one variant, the panel anchor 8 constitutes an elongated body that is integrated with the band. The panel anchors longitudinal axis is parallel with the cross-sectional long side of the band. In one version, the panel anchor constitutes an elongated body that is integrated with the band. The panel anchors longitudinal axis is parallel with the cross-sectional long side of the band. The opening in the panel, aimed to receive the anchor, has a shape that is the sum of a circle and a long and narrow shape that are overlapping. The width of the long and narrow part 13 is smaller than the diameter of the circular part 12 but slightly bigger than the width w of the band and the length of the long and narrow part 13 is bigger than the diameter of the circular part 12 and slightly longer than the panel anchor 8. The cable tie changes direction at least one time close to or at the integration point 11 between the anchor and the band. The angle and radius of the curves are designed to facilitate the adaption to panels of different thicknesses. It is an advantage, as will be shown later, that the band on each side of the anchor has an outward tension after being mounted into the panel. It is probably best to change direction at least three times in order to keep a relatively straight overall shape of the entire cable tie.

In another version of the invention the panel anchor is an integrated flat square with a flexible part that allows it to be bent into an elongated body that can be mounted into a hole in the panel. This panel anchor have segments that are weaker and therefor can bend, turning the flat panel anchor 22 into a folded panel anchor 27, 39. The weaker segments are elongated sections that are perpendicular to the cable ties elongated axis. The weakening of these segments are made either by grooves 23, cut-through slots 24 or by an elastomeric bridge 26, a part that are integrated with the cable tie on both sides. The weakening can also be made by a combination of the three and can, it can have one segment or a number of segments. After folding the folded panel anchor 27, 39 gets an elongated shape with a V- or U-shaped cross section.

The opening in the panel, aimed to receive the anchor, has a shape that is long and narrow slot or the sum of a circle and a long and narrow shape that are overlapping. The width of the long and narrow part 13 is slightly bigger than the width w of the band and the length of the long and narrow part 13 is slightly longer than the panel anchor 8, 39.

The unfolded version of the cable tie, changes direction at least one time close to or at the integration point 11 between the anchor and the band. The angle and radius of the curves are designed to facilitate the adaption to panels of different thicknesses. It is an advantage, as will be shown later, that the band on each side of the anchor has an outward tension after being mounted into the panel. It is probably best to change direction at least three times in order to keep a relatively straight overall shape of the entire cable tie. This straight overall shape will be beneficial for the manufacturing processes, the molding tool cost and the handling process. It will be simpler to pack, store and use them. On each side of the anchor the band can have short sections where it is thinner, the reason for that is to control where the bends will occur and by that helping to adapt to different panel thicknesses. By making it thinner it bends easier and that reduces the stress in these areas. PA, polyamide often used in cable ties have a tendency to break if the bending stress is high combined with a low humidity in the air. PA absorbs and releases water as the surrounding air humidity changes, so in the middle of the winter in the northern parts of Europe it might break when the bending forces are too tough. The indented fastening points 15 will also reduce stress and make the section that will bend close to the anchor a bit longer. The folded version 21 is all flat before folding and therefore easier to pack, store and use since it is less likely to be tangled to each other.

The direction of the long and narrow part of the opening shall be perpendicular to the directions of the cables, tubes or hoses to be mounted to the panel.

The mounting starts with a bending of the two sides on each side of the anchor towards each other so that the panel anchor 8 or the folded panel anchor 39 can be mounted into the hole without the cable tie touching the edges of the hole too much. First the panel anchor is mounted through the opening parallel with the elongated part of the opening until it is completely on the backside of panel. After that the cable tie is rotated 90° around the normal axis of the panel in any direction and then the bending is released. The band is now trying to restore the bend to its original shape and by doing that the cable tie will be fixed into the two ends of the elongated part of the opening and thereby the band is blocked from further rotation. In this situation, the cable tie is mounted quite loosely but still locked in all directions plus rotation. Then when it is tightened around a cable the whole area around the anchor is tightened, pushing the anchor against the backside of the panel, it is fixed. Since the 90° rotation can be chosen in any direction, the choice is made so that the making of the loop is easy, the side where the space is sufficient at that specific spot.

The distance between the locking mechanism and the anchor on the cable tie should not exceed the diameter of the smallest cable to be mounted. To make the fixation even more robust small extrusions from the anchor can extrude up in the circular part of the opening, shown in FIGS. 4a and 4b. The reason is to avoid movements of the cable when the panel is exposed to high vibrations. These extrusions can preferably be segments of a circle with a common diameter d slightly smaller than the round part of the opening. This enhances the fixation towards movement in the same plane as the panel. It also takes pressure of the thinner parts of the cable tie on each side of the anchor and avoid fatigue of these parts due to vibrations of the anchor along the panels backside.

As an example, the panel thickness that one cable tie type can fit, might be in the range of 1.5-4 mm And that covers most of the plates used when building cars, airplanes and machines that needs a lot of mounted cables. When the panel is thick it's an advantage with a chamfer on the openings front side edges, at least on the circular part. It might also be an advantage to make the opening slightly bigger when placed on a thicker panel. In that way, the range that one single cable tie can fit will be increased. Another advantage with the panel anchor of this type is that it also can fit in openings on panels that are not flat. Vaulted or curved plates, that are common in cars, airplanes and machines is not a problem, and it works for the same reason as it can handle different thicknesses.

The opening in the panel having a round part in the center is preferably designed in a way that makes it possible to create it by drilling three holes, two small and then the one big in between. Punching is very effective, even the chamfer mentioned earlier can be made with the same punch. Milling is another alternative. It is possible to drill it by hand also if necessary with the help of a drilling fixture. A drilling fixture would help to place the small holes at a correct distance from each other, and then act as a guide when placing the big hole in between them.

This cable tie can also be used for marking cables, parts and details with numbers, text or symbols. Then all you need is a small plate with text or other information, the marking plate shall also contain the opening. Then the anchor is mounted to the marking plate opening before the cable tie is mounted and tightened around the detail to be marked. It is also possible to have two anchors on the same cable tie, one for the marking plate and one for mounting the cables against a panel.

The cable ties are easy to manufacture as molded parts, a simple tool with only two halves, and no need for any moving inserts in the tool. There might be some problems in handling the cable ties due to the geometry of the anchor which gives them a tendency to hook up to each other. That also makes it a bit more difficult for the packaging. A solution might be to mold a number of them together with small bridges in between that are broken when removing one. Since these products normally are produced in very high volumes it is preferred to mold a number of details in one tool anyway. They could stick together all the way to the end user. Yet another way could be to make some sort of holder or magazine in order to make it easier to pick one at the time, without hooking into a neighbor. The version with an elastomeric bridge will have to be molded in a 2K molding tool that first molds the plastic and then the elastomer that bonds hard to the plastic.

Even though one type can fit into different panel thicknesses, there will probably be a need for a number of variations, such as sizes, colors, an extra robust version, an extra big loop or a version with double anchors, mounting and marking. Anyway there's a big probability that one type is sufficient to do the cable attaching job in one machine.

To summarize, the existing cable ties often have one or more of the following drawbacks:
1. Difficult to mount to a panel without access to the backside of the panel.
2. Difficult to dismount from a panel without access to the backside of the panel.
3. Is only designed for one or two panel thicknesses
4. Protrudes too much from the panel.
5. Gives a bad EMC-immunity to the cables mounted.
6. Lack of locking against rotation of the cable tie.
7. Uses adhesive that dries out and loosens with time, and/or is hard to dismount.
8. Is not robust against strong vibrations.
9. Need threads, making the panel more expensive and takes more time to mount.
10. Is made of two parts with increasing costs.

The points above are also the problems that this invention claims to be the solution to.

The most important benefits with the invention are:
1. One type can handle many panel thicknesses.
2. Simple to mount.
3. Simple to dismount.
4. Very robust against strong vibrations.
5. Simple and cheap to manufacture.
6. Takes up very little space.
7. Does not protrude much on the backside.
8. Backside can be inaccessible both for mounting and dismounting.
9. Gives good EMC-immunity to electrical cables.
10. Can be mounted on panels that are not flat but vaulted or bent.

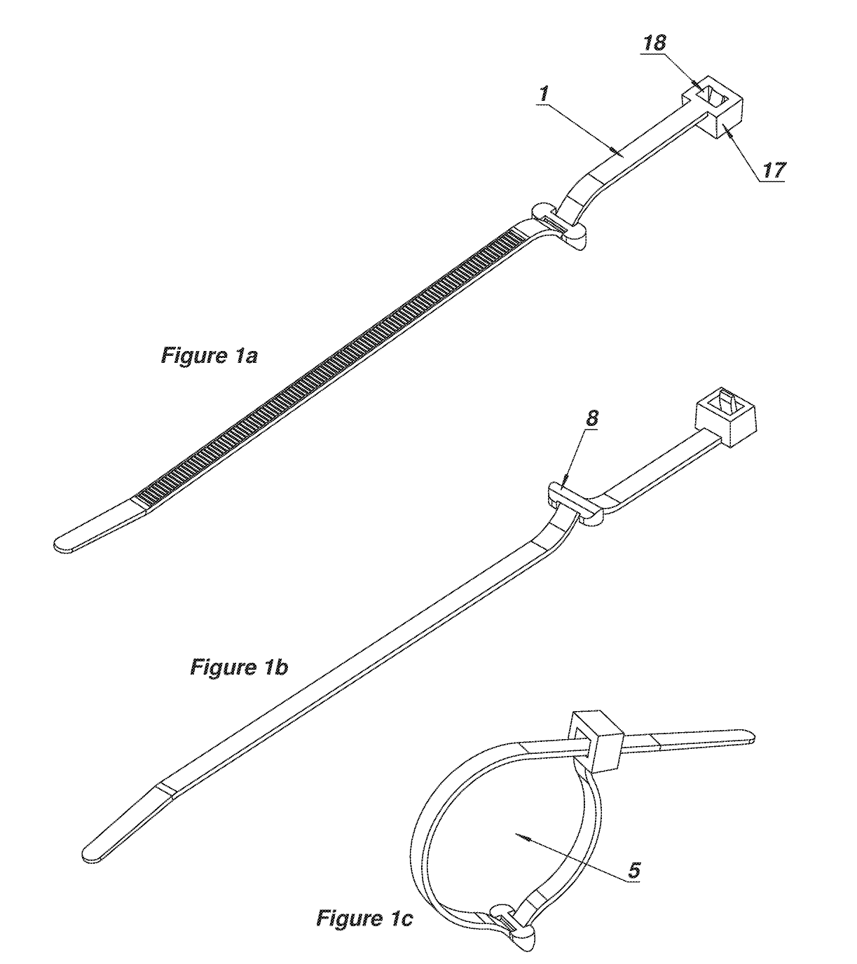

As noted above, the figures provided herein can be described as follows: FIGS. 1a, 1b, and 1c show a cable tie 1 with a panel anchor 8 and an example of means 17, 18 forming a loop 5 in different perspectives, according to exemplary embodiments of the present disclosure;

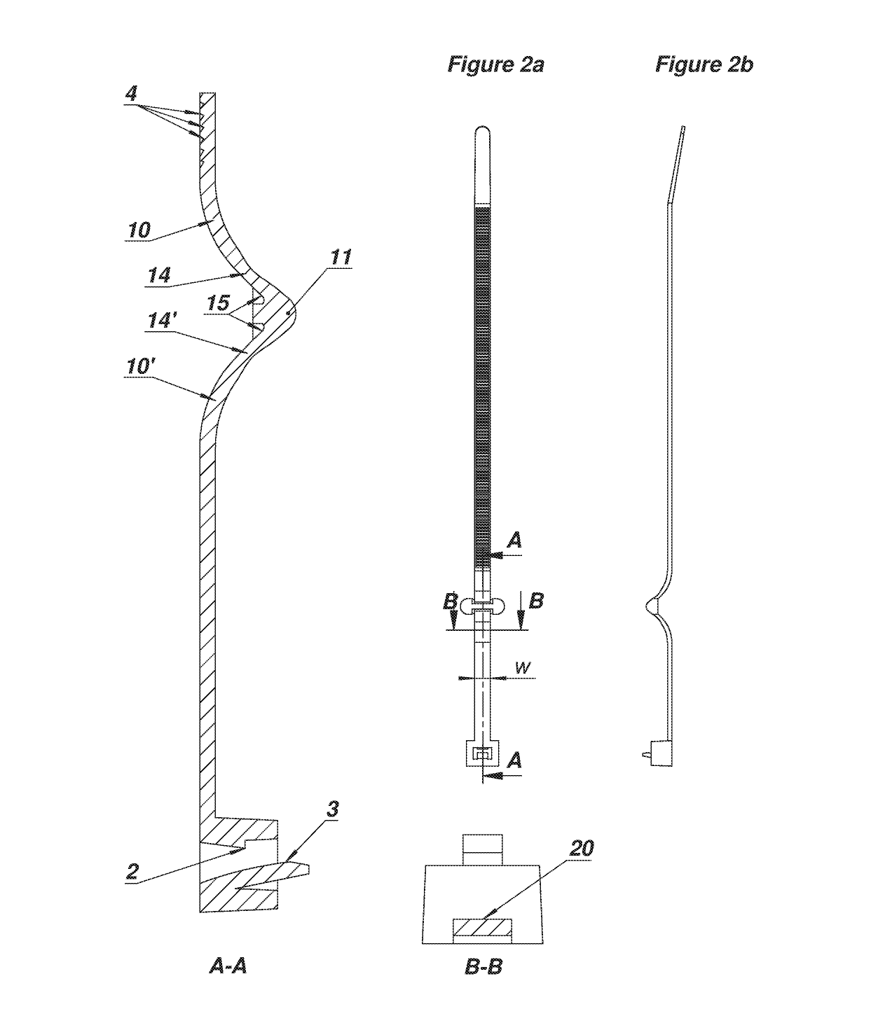

FIG. 2a shows a main view of a cable tie 1 with associated section view A-A and example of details 2, 3, 4 for forming a loop 5 and direction changes 10, 10′ and at point 11, and also section B-B showing the cross section of the band 20 in the vicinity of the panel anchor 8, according to an exemplary embodiment of the present disclosure;

FIG. 2b shows a projected view from FIG. 2a, according to an exemplary embodiment of the present disclosure;

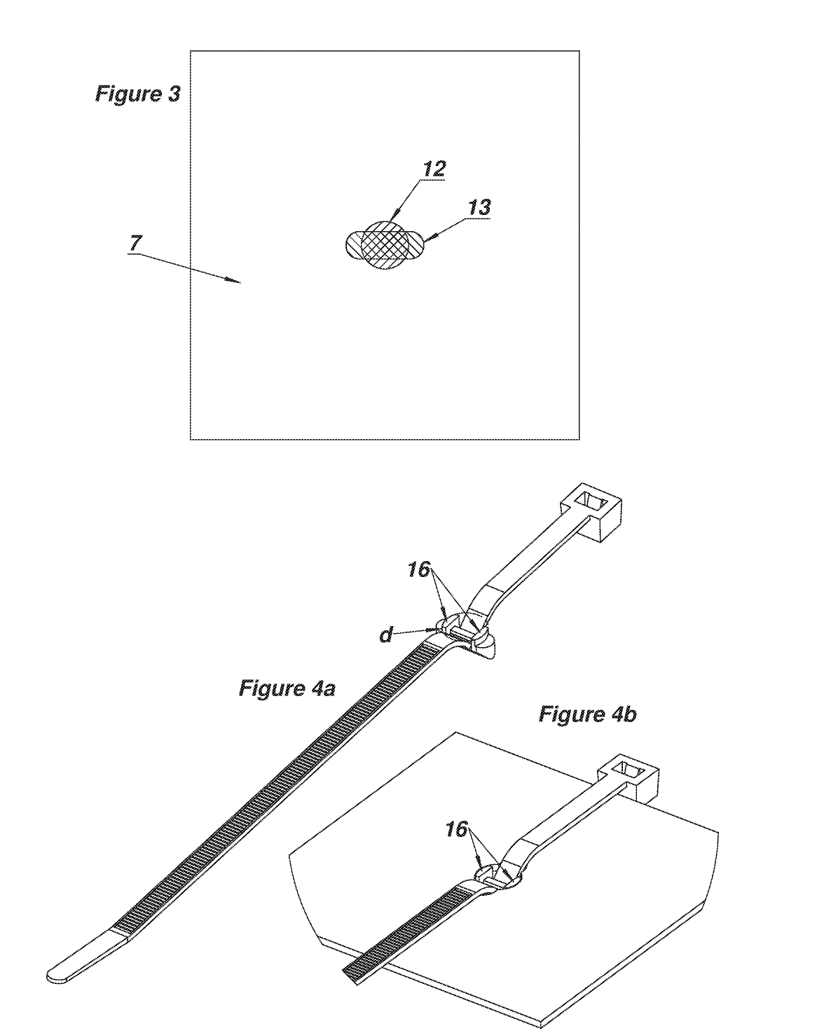

FIG. 3 shows the design of the opening 9 in the panel 7, with an elongated part 13 and a circular part 12, according to an exemplary embodiment of the present disclosure;

FIG. 4a shows an alternative panel anchor 8 with extruded segments of a circle 16, according to an exemplary embodiment of the present disclosure;

FIG. 4b shows an alternative panel anchor 8 with extruded segments of a circle 16 mounted in a panel 7, according to an exemplary embodiment of the present disclosure;

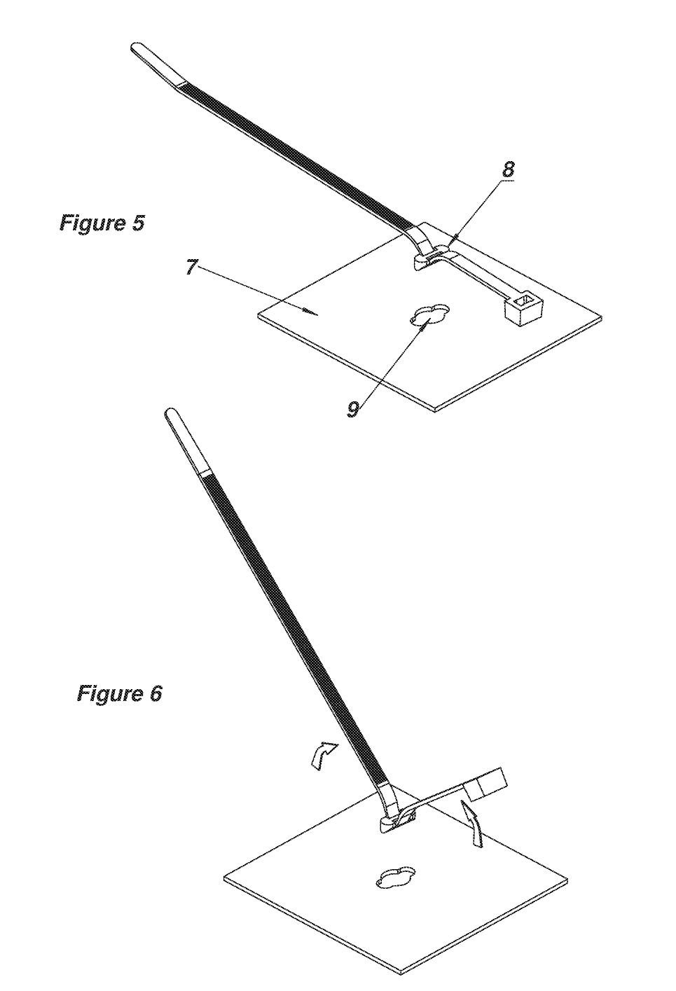

FIG. 5 shows the cable tie 1 with panel 7 before mounting, according to an exemplary embodiment of the present disclosure;

FIG. 6 shows the gentle bending of the cable tie prior to mounting, according to an exemplary embodiment of the present disclosure;

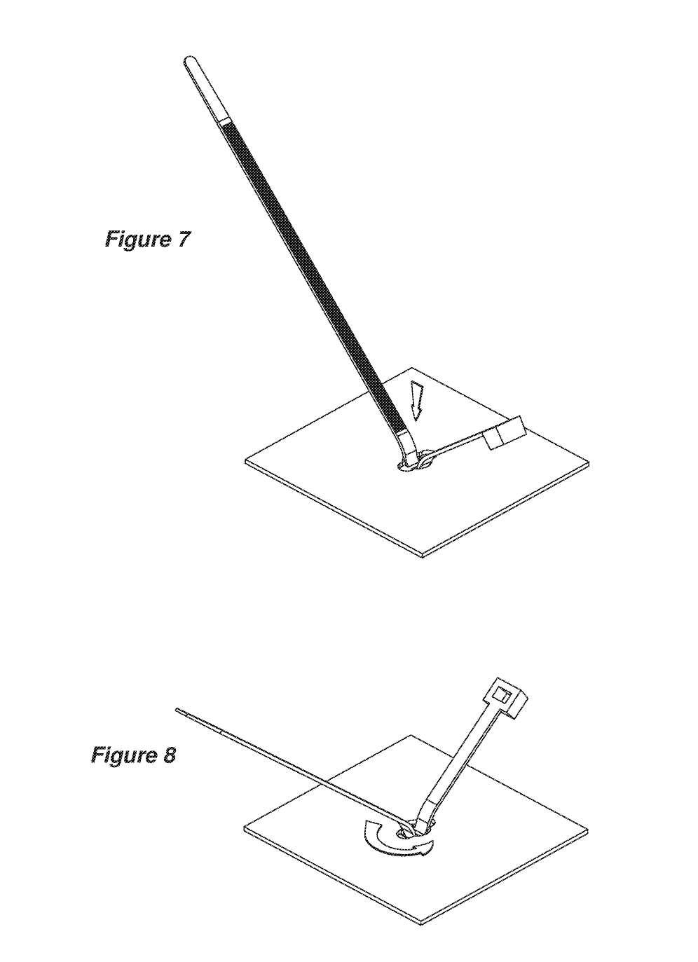

FIG. 7 shows how the panel anchor 8 is inserted into the panel 7, according to an exemplary embodiment of the present disclosure;

FIG. 8 shows how the cable tie 1 is rotated 90° in the opening 9, according to an exemplary embodiment of the present disclosure;

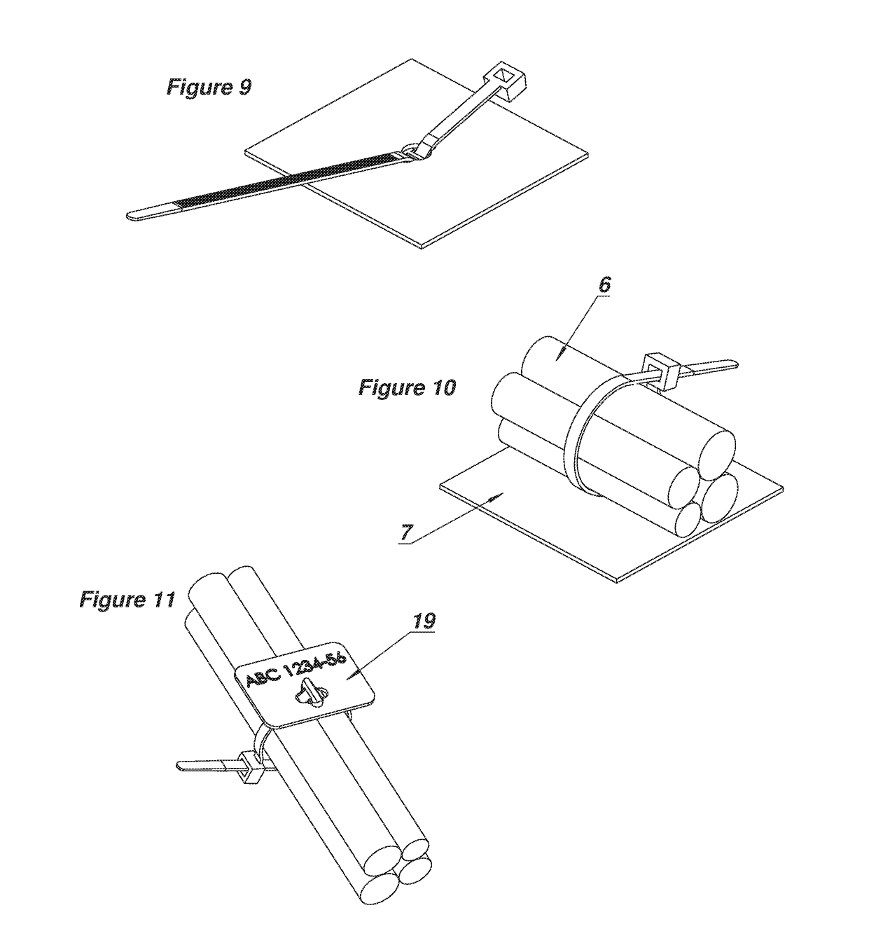

FIG. 9 shows the cable tie after recovering from the initial bend, according to an exemplary embodiment of the present disclosure;

FIG. 10 shows how the cable tie have formed a loop 5 around four cables 6 that have been mounted against the panel 7, according to an exemplary embodiment of the present disclosure;

FIG. 11 shows marking of cables with the use of a marking badge 19, according to an exemplary embodiment of the present disclosure;

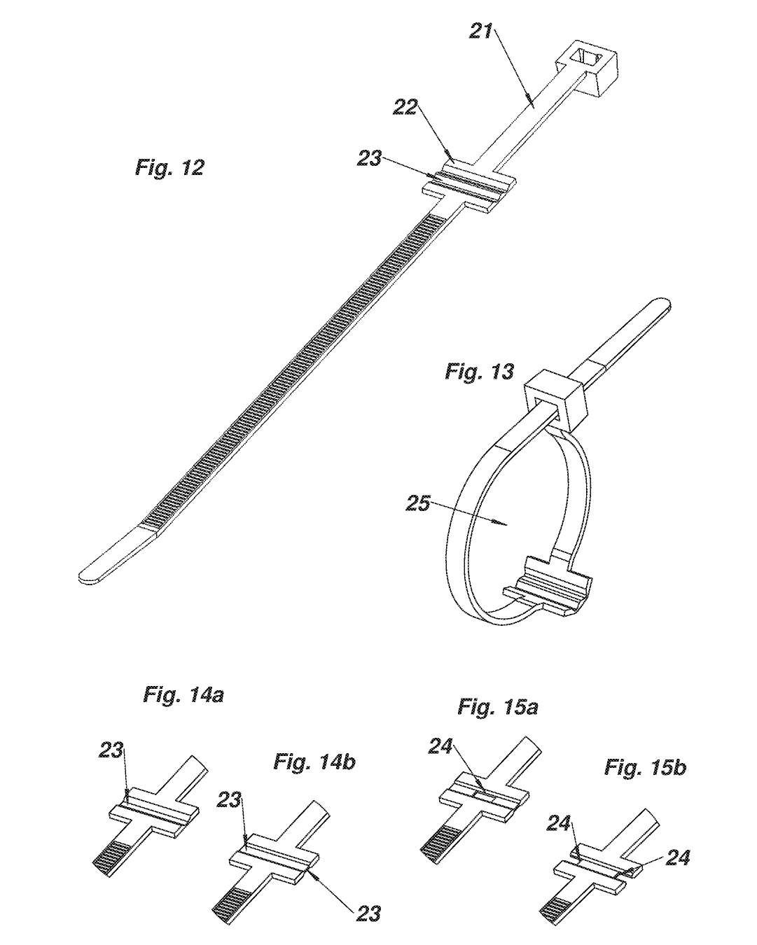

FIG. 12 shows a cable tie 21 with a flat panel anchor 22 containing grooves 23, according to an exemplary embodiment of the present disclosure;

FIG. 13 shows a cable tie forming a loop 25, according to an exemplary embodiment of the present disclosure;

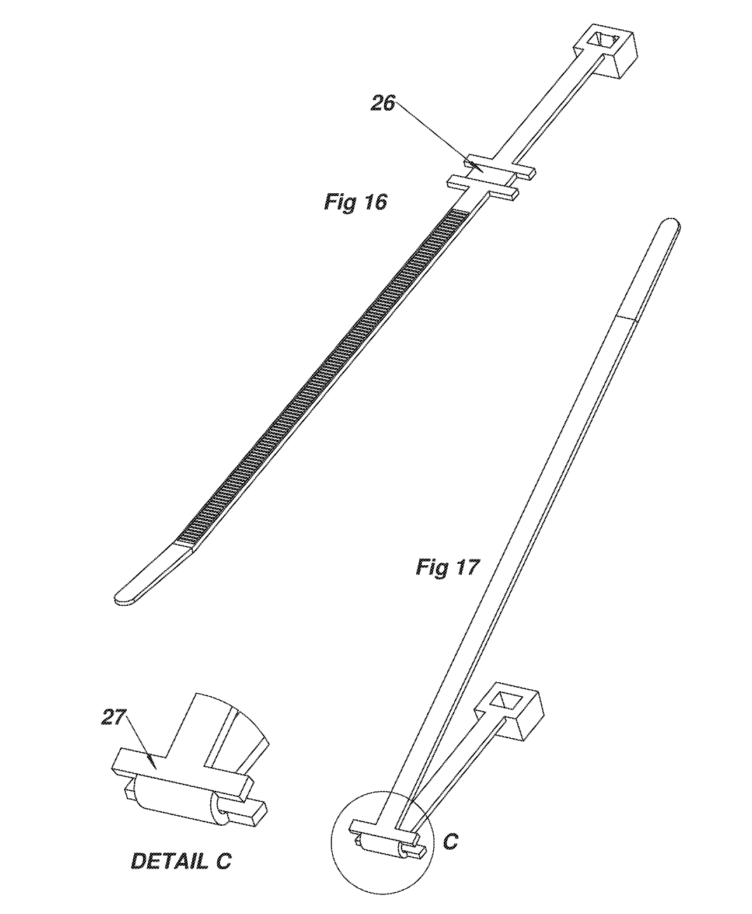

FIGS. 14a, 14b, 15a and 15b show the panel anchor with its weakened segments made of grooves 23 and/or cut through slots 24, according to exemplary embodiments of the present disclosure;

FIG. 16 shows a cable tie with an elastomeric bridge 26, according to an exemplary embodiment of the present disclosure;

FIG. 17 shows a folded cable tie with an elastomeric bridge where the panel anchor is folded, the folded panel anchor 27 with the elastomeric bridge is shown enlarged in detail C, according to an exemplary embodiment of the present disclosure;

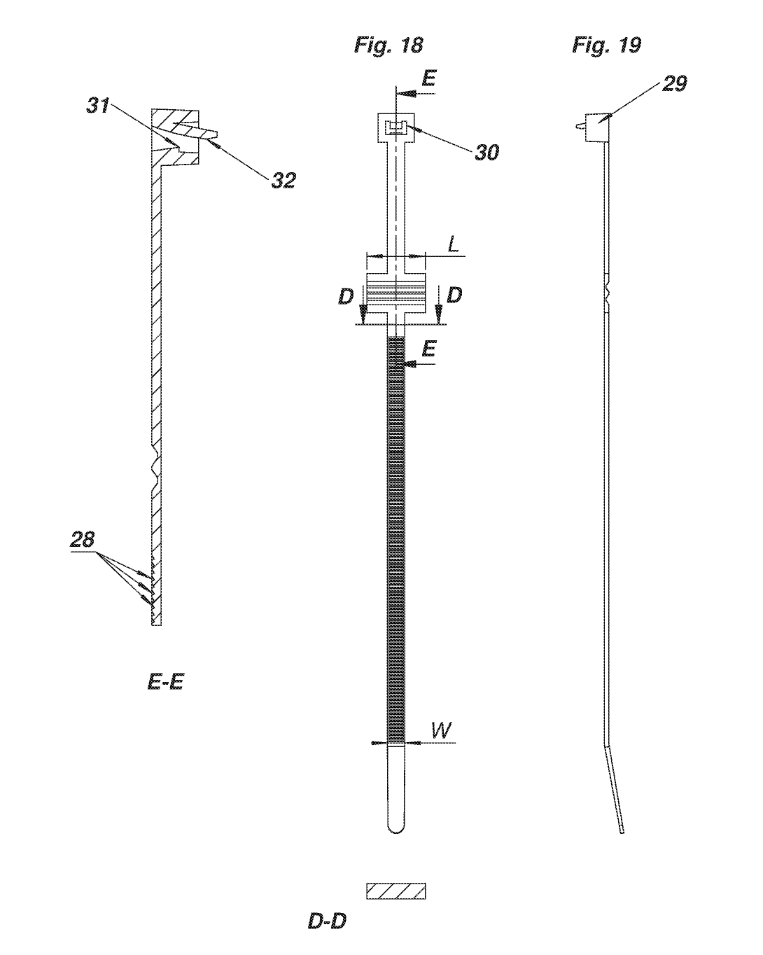

FIG. 18 shows a main view of the cable tie with the length L of the panel anchor, the width W of the band and the hole of the locking device 30 with associated section view E-E showing details 28, 31, 32 for forming a loop, section view D-D shows the cross section of the band in the vicinity of the panel anchor, according to an exemplary embodiment of the present disclosure;

FIG. 19 shows a projected view from FIG. 18 and the locking device 29, according to an exemplary embodiment of the present disclosure;

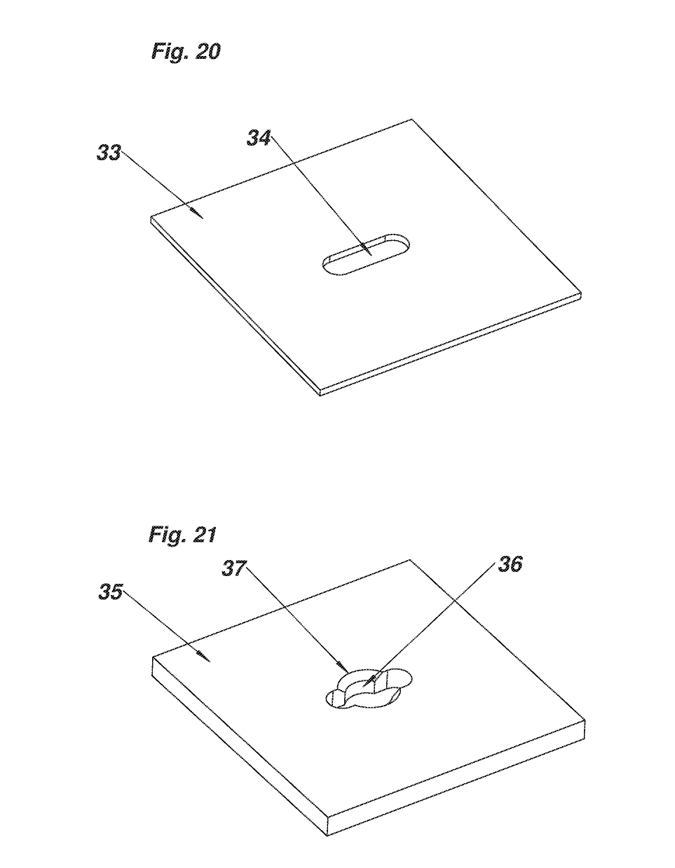

FIG. 20 shows the long and narrow opening 34 in the thin panel 33, according to an exemplary embodiment of the present disclosure;

FIG. 21 shows an alternative panel 35 that is thicker and therefore also include a circular part 36 of the opening and a chamfer 37, according to an exemplary embodiment of the present disclosure;

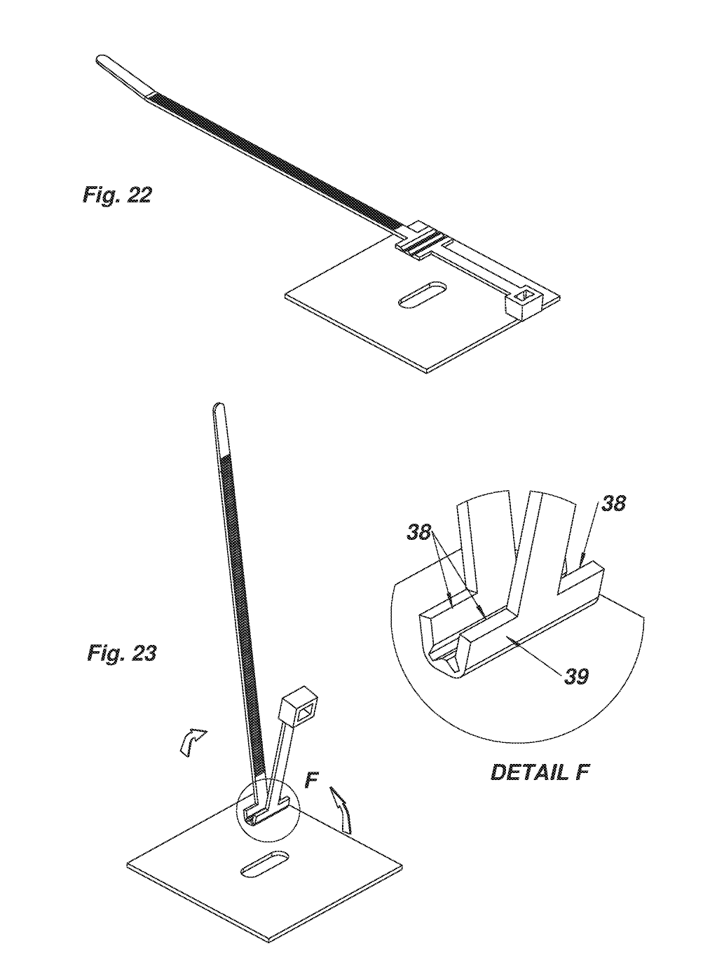

FIG. 22 shows the cable tie with a panel 33 before mounting, according to an exemplary embodiment of the present disclosure;

FIG. 23 shows the bending of the cable tie prior to mounting, detail F shows the folded panel anchor 39 with grooves and the edges 38, according to an exemplary embodiment of the present disclosure;

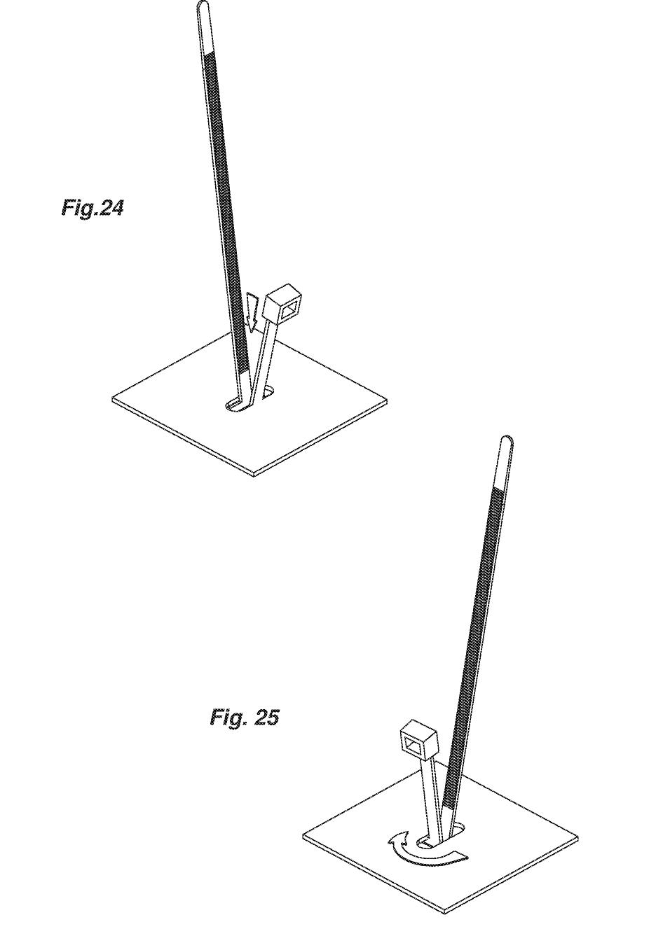

FIG. 24 shows how the folded panel anchor 39 is inserted into the panel opening 34, according to an exemplary embodiment of the present disclosure;

FIG. 25 shows how the cable tie 21 is rotated 90° in the panel opening 34, according to an exemplary embodiment of the present disclosure;

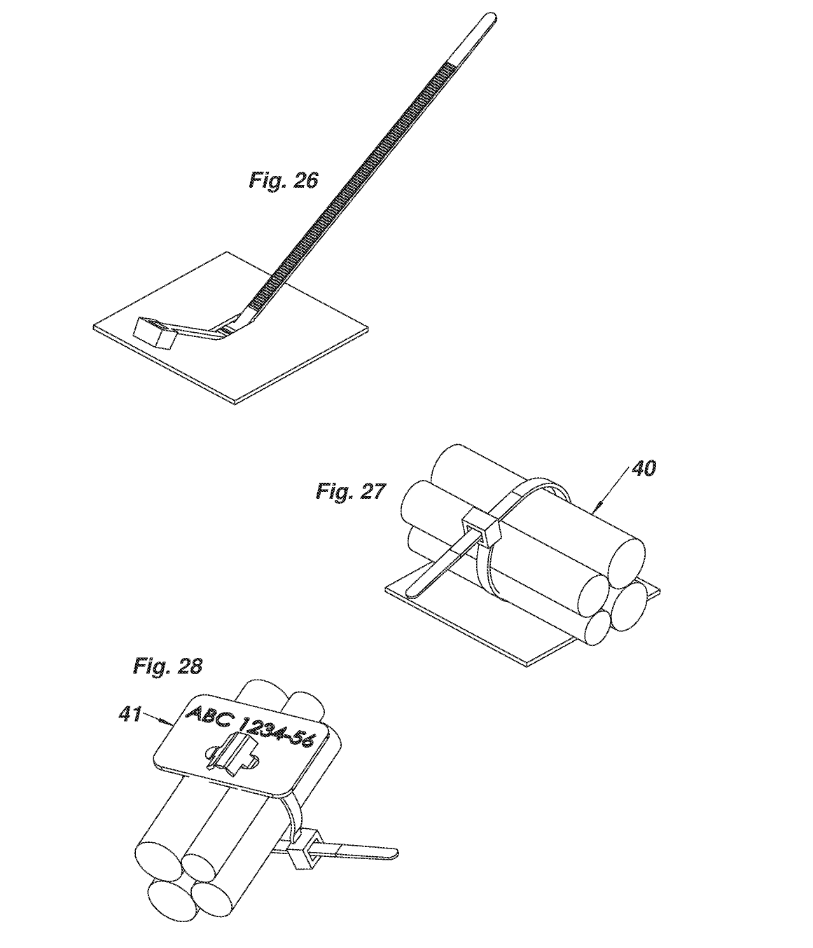

FIG. 26 shows the cable tie after recovering from the initial bend, according to an exemplary embodiment of the present disclosure;

FIG. 27 shows how the cable tie have formed a loop around four cables 40, according to an exemplary embodiment of the present disclosure; and

FIG. 28 shows a panel anchor mounted into an opening in a marking badge 41, according to an exemplary embodiment of the present disclosure.

While various embodiments of cable ties for mounting cables against a panel and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A cable tie with means to form a loop, said cable tie is intended to be used for attaching cables or similar details against a panel with the use of an integrated panel anchor, said panel anchor is mounted into an opening in said panel, said cable tie is characterized by;
A. having an elongated band in a vicinity of the panel anchor;
B. having the integrated panel anchor having a wide flat square or rectangular shape with one or more weaker elongated segments perpendicular to a longitudinal axis of the cable tie and where said weaker segments are;
i. made of grooves and/or;
ii. made of cut through slots and/or;
iii. made of an elastomeric bridge; and;
C. that said panel anchor can be folded in said weaker segments into a folded panel anchor and;
D. that said folded panel anchor is intended to be mounted in through a long and narrow opening of the panel and that the cable tie thereafter is rotated 90° relative to the panel and around a normal axis of the panel so that edges of the folded panel anchor that are parallel to the weaker segments are locked against a back side of the panel and the cable tie on each side of the panel anchor is locked against further rotation on a front side in both ends of the long and narrow opening due to remaining tension from said folding.

2. A cable tie according to claim 1 that is intended to be mounted in panels of different thicknesses.

3. A cable tie according to claim 1 where parts of the band have at least one of its two flattened surfaces ribbed.

4. A cable tie as in claim 3 with a locking device in one of its ends consisting of a hole aimed to receive at least part of the ribbed band therein and completely therethrough and thus creating a loop where a locking mechanism locks the loop in a tightened position.

5. A cable tie as in claim 4 with a release mechanism to release the locking mechanism and by that opening up the loop.

6. A cable tie according to claim 1 where the cable tie is made of plastic.

7. A cable tie according to claim 1 where the panel is replaced with a marking badge.
